(19) United States
(12) Patent Application Publication
(10) Pub. No.: US 2012/0169038 A1
(43) Pub. Date: Jul. 5, 2012

(54) DOCUMENT SECURITY METHOD

(75) Inventor: David C. Myers, SR., Monticello, FL (US)

(73) Assignee: THE STATE OF FLORIDA DEPARTMENT OF THE LOTTERY, Tallahassee, FL (US)

(21) Appl. No.: 12/980,402

(22) Filed: Dec. 29, 2010

(51) Int. Cl. B42D 15/00; B05D 1/36; B05D 3/06

(52) U.S. Cl. 283/94; 427/532

(57) ABSTRACT

A method of enhancing the security of instant or scratch-off tickets is disclosed in which a security marking is applied to the substrate of the ticket during the printing process which is invisible to the human eye except upon the application of radiant energy to the ticket.

### FIELD OF THE INVENTION

This invention relates to document security, and, more particularly, to a method of enhancing the security of scratch-off type lottery tickets as part of the process of printing such tickets.

### BACKGROUND OF THE INVENTION

Many State lotteries, gaming facilities and other establishments operate games or promotional events involving “instant” or scratch-off tickets. Generally, scratch-off tickets include a pattern of play indicia that is covered by a scratch-off layer. The scratch-off layer may be removed to expose the indicia hidden below, and prizes may be awarded depending on the indicia uncovered.

The method of manufacturing scratch-off tickets employs a unique printing process typically involving multi-million ticket runs with high speed printers capable of printing hundreds of tickets per second. The tickets typically include a substrate such as paper on which multiple layers of overlapping inks or dyes are applied in a single, high-speed, fast-drying process. Ten or more layers of adhering and non-adhering inks or dyes may be used to create a scratch-off ticket having the desired graphic appearance with a scratch-off layer that may be relatively easily removed.

The widespread use and acceptance of scratch-off tickets in lotteries and other games has resulted in efforts to introduce counterfeit versions of such tickets, and attempts to tamper with such tickets and/or defeat the security measures employed on them. Traditional security measures include the use of watermarks, metameric inks or dyes, infrared markings and other means which are not visible to the naked eye. These solutions have varying degrees of effectiveness but often add to the incremental cost of the tickets which can be significant given the large number of tickets printed for State lotteries and other high-volume games or promotions.

### SUMMARY OF THE INVENTION

This invention is directed to a method of enhancing the security of instant or scratch-off tickets by the application of an effective, low-cost security marking to the substrate of the ticket during the printing process which is invisible to the human eye except upon the application of radiant energy to the ticket.

An offset, gravure, flexographic or hybrid high speed printing process is preferably employed in the method of this invention to print multiple layers of adhering and non-adhering inks or dyes in overlapping relationship over a discrete area on the inside surface of a substrate. Such multiple layers of ink or dye include at least one layer of play data for the scratch-off game, and at least one scratch-off layer which is removed to view the play data. Printing processes of this type utilize a rotating cylinder having a surface which receives the ink or dye, and an impression roller that forms a nip with the rotating cylinder. The substrate is fed into the nip between the rotating cylinder and impression roller and then pressure is applied to the substrate and rotating cylinder by the impression roller to transfer the ink or dye to the substrate.

In the presently preferred embodiment, the surface of the rotating cylinder is etched or engraved with a security design, which, when applied to the substrate, is spaced from the area where the multiple layers of ink or dye are applied. The security design is hidden from view by ink or dye forming the top layer of the scratch-off ticket, and by the substrate, except upon the application of radiant energy to the ticket.

The method of this invention, and the scratch-off ticket produced in accordance with such method, provide an extra measure of security against counterfeit tickets. The security design is applied to the substrate at the same time as one or more other layers of the ticket, with minimal extra cost. An additional etching or engraving on the rotating cylinder forming the security design is all that is required, and the design is applied during the course of a normal printing run without the need for special inks or dyes and without further processing steps in the printing operation.

### DESCRIPTION OF THE DRAWINGS

The structure, operation and advantages of the presently preferred embodiment of this invention will become further apparent upon consideration of the following description, taken in conjunction with the accompanying drawings, wherein:

FIG. 1 is a schematic view of a gravure printing process including a gravure cylinder and an impression roll;

FIG. 2 is a side view of the gravure cylinder shown in FIG. 1 in which a first engraving, and a second engraving depicting a security design, are illustrated; and

FIG. 3 is a schematic, exploded side view of a scratch-off ticket made in accordance with the method of this invention.

### DETAILED DESCRIPTION OF THE INVENTION

This invention is directed to a method of enhancing the security of instant or “scratch-off” type tickets employed in State lotteries, gaming establishments, promotions and the like. A number of printing processes may be utilized in printing scratch-off tickets, such as offset, gravure, flexographic, hybrid or others capable of applying multiple layers of adhering and non-adhering inks or dyes in a high-speed, fast-drying process. A gravure process is schematically depicted in the drawings for purposes of illustrating the method of this invention.

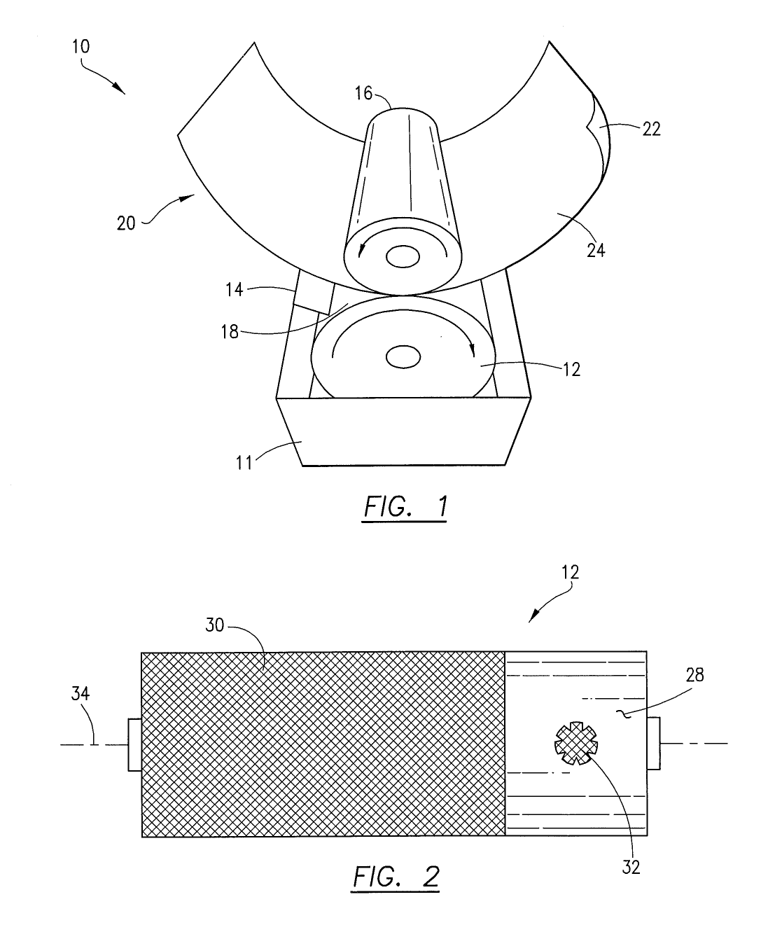

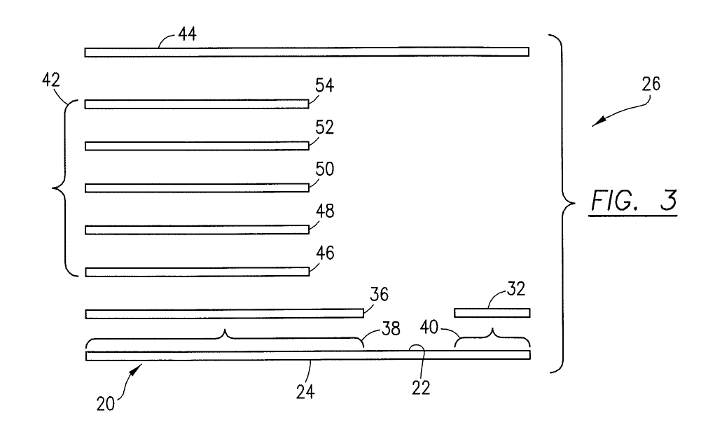

Referring now to FIGS. 1 and 2, a printing station 10 of a gravure printing process is diagrammatically illustrated including an ink fountain 11, a gravure cylinder 12, a doctor blade 14 and an impression roller 16. The gravure cylinder 12 is rotatable in a clockwise direction in the illustration depicted in FIG. 1, whereas the impression roller 16 rotates in the opposite direction. The impression roller 16 is located relative to the gravure cylinder 12 to form a nip 18 between them though which a substrate 20, such as cardboard or paper, may be directed. The substrate 20 has an inner surface 22 that receives ink or dye, as discussed below, and an opposite, outer surface 24.

As described more fully below in connection with a discussion of a scratch-off ticket 26 made in accordance with the method of this invention, instant or scratch-off tickets typically include a number of overlapping layers of ink or dye applied to a substrate. Depending upon functional requirements, the composition of the ink or dye may change from layer to layer of the ticket. The diagrammatic illustration in FIG. 1 is intended to depict one printing station 10 of a gravure printing system that is capable of applying one layer of ink or dye to substrate 20. It is contemplated that the gravure printing system would include one or more other printing stations (not shown) similar to the one depicted in FIG. 1 in order to print the other layers of ink or dye needed to form the completed ticket 26.

The gravure cylinder 12 has a surface 28 formed with recessed cell wells that are etched or engraved to differing depths and sizes. In the presently preferred embodiment, a first engraving 30 is formed on the surface 28 of the gravure cylinder 12. A second engraving, depicted as a security design 32, is also formed on the cylinder surface 28 but is spaced from the first engraving along the longitudinal axis 34 of the gravure cylinder 12.

Preferably, a high carbon ink, dye or other light-blocking material is placed in the ink fountain 11 within which the gravure cylinder 12 is partially immersed during operation of the printing station 10. The ink or dye is captured in the recessed cell wells forming the first engraving 30, and within the recessed cell wells forming security design 32. As the gravure cylinder 12 rotates relative to the impression roller 16, the doctor blade 14 wipes away excess ink or dye from the surface 28 of the gravure cylinder 12. The substrate 20 enters the nip 18 between the gravure cylinder 12 and impression roller 16, and then under the application of pressure by the impression roller 16 ink or dye is transferred from the gravure cylinder 12 onto the inner surface 22 of the substrate 20.

With additional reference to FIG. 3 of the drawings, the printing station 10 of the gravure printing system schematically illustrated in FIGS. 1 and 2 is operative to apply a bottom layer 36 of ink or dye along a first area 38 on the inner surface 22 of the substrate 20, and to simultaneously apply the security design 32 onto a second area 40 of the inner surface 22 which is spaced from the first area 38. As noted above, a high carbon ink or dye, or other light-blocking material, is employed in the printing station 10 shown in FIGS. 1 and 2 so that the bottom layer 36 and security design 32 are essentially opaque to the passage of light.

An exploded, side view of the scratch-off ticket 26 is depicted in FIG. 3 for purposes of illustration. The detailed composition of the ink or dye forming the other layers of the ticket 26 does not form a part of this invention, and is therefore discussed only generally herein. A number of intermediate layers 42 of ink, dye and/or other components are located between the bottom layer 36 and a decorative, top layer 44 discussed in more detail below. All of the intermediate layers 42 overlap one another and are located within the first area 38 on the inner surface 22 of the substrate 20.

A white opacity layer 46 is applied directly over the bottom layer 36, preferably including or comprising titanium oxide which is effective to reflect radiant energy applied to the ticket 26 from the outside surface 24 of the substrate 20. A play plate layer 48, comprising ink or dye with a small amount of enamel, is applied over the white opacity layer 46. The play data for the ticket 26 is provided in the data layer 50 located atop the play plate layer 48. The play data may include numbers, designs or other indicia that denote one or more winning combinations for which a prize may be awarded according to the rules of the particular game. A silicon-based scratch-release layer 52 is then applied over the data layer 50, followed by an opaque or blocking layer 54 located between the scratch-release layer 52 and top layer 44. The blocking layer 54 may be formed of high carbon ink or dye, similar to bottom layer 36, which adheres to and is removable with the scratch-release layer 52.

As noted above and depicted in FIG. 3, all of the layers 46-54 forming the intermediate layers 42 of the ticket 26 overlie the bottom layer 36 and are located within the first area 38 of the substrate 20. The top layer 44 may include artwork and other decorative designs to enhance the aesthetic appeal of the ticket 26. As shown in FIG. 3, the top layer 44 covers not only the intermediate layers 42 and bottom layer 36 located within the first area 38 of the substrate 20, but also covers the security design 32 located within the second area 40 of the substrate 20.

The security design 32 is hidden from view by the naked eye by both the substrate 20 and the top layer 44 of the ticket 26. However, when radiant energy such as from an incandescent or other light source is applied to the ticket 26, the security design 32 is visible to the naked eye thus providing an indication of the authenticity of the ticket 26. In particular, radiant energy applied to the outer surface 24 of the substrate 20 causes the security design 32 to be visible when looking at the top layer 44 of the ticket 26, and radiant energy applied to the top layer 44 causes the security design 32 to be visible when viewing the outer surface 24 of substrate 20. The presence of the security design 32 is easy to detect when the ticket 26 is illuminated because the security design 32 is spaced from the bottom layer 36, and intermediate layers 46-54, and located solely within the second area 40 of the substrate 20.

The method of this invention provides an inexpensive and reliable means of enhancing the security of the resulting scratch-off ticket 26. The security design 32 may be applied by a single gravure cylinder 12 simultaneously with the application of the bottom layer 36 to the substrate 20 and using the same ink or dye. A minor second engraving operation is all that is required on the gravure cylinder 12. Further, the security design 32 is easy for a lottery worker or other official to detect at the time of redemption of a supposed winning ticket by simply shining a light source onto the outside surface 24 of the substrate 20 or onto the top layer 44 of the ticket 26.

While the invention has been described with reference to a preferred embodiment, it should be understood by those skilled in the art that various changes may be made and equivalents substituted for elements thereof without departing from the scope of the invention. In addition, many modifications may be made to adapt a particular situation or material to the teachings of the invention without departing from the essential scope thereof.

As noted above, the particular configuration of the scratch-off ticket 26 described herein is not intended to in any way limit the scope of this invention. It is contemplated that more, less and/or different layers of ink, dye or other materials may be employed to print a scratch-off ticket than those discussed in connection with a description of ticket 26. Further, the particular appearance of the security design 32 shown in FIG. 2 is for purposes of illustration only, and it could take essentially any other form.

Therefore, it is intended that the invention not be limited to the particular embodiment disclosed as the best mode contemplated for carrying out this invention, but that the invention will include all embodiments falling within the scope of the appended claims.

I claim:

1. A method of enhancing the security of a document, comprising:
(a) providing a substrate having a first surface and an opposed second surface;
(b) applying a bottom layer of ink or dye onto a first area on the first surface of the substrate;
(c) applying a security design onto a second area on the first surface of the substrate, the second area being spaced from the first area;
(d) applying at least one intermediate layer of ink or dye that overlaps the bottom layer and is located within the first area;
(e) applying a top layer of ink or dye that overlaps the at least one intermediate layer and covers the security design so that the security design is not visible to the human eye except upon the application of a source of radiant energy to the second surface of the substrate or to the top layer of ink or dye.

2. The method of claim 1 in which step (b) comprises applying a bottom layer of ink or dye onto the first area on the first surface of the substrate that blocks the passage of light.

3. The method of claim 1 in which step (c) comprises applying light-blocking ink or dye onto the second area on the first surface of the substrate to form the security design.

4. A method of enhancing the security of a scratch-off lottery ticket, comprising:
(a) providing a substrate having a first surface and an opposed second surface;
(b) applying a bottom layer of ink or dye onto a first area on the first surface of the substrate;
(c) applying a security design onto a second area on the first surface of the substrate, the second area being spaced from the first area on the first surface of the substrate;
(d) applying at least one intermediate layer of ink or dye that overlaps the bottom layer and is located within the first area of the substrate, the at least one intermediate layer including play data;
(e) applying a decorative top layer of ink or dye that overlaps the at least one intermediate layer and covers the security design so that the security design is not visible to the human eye except upon the application of a source of radiant energy to the second surface of the substrate or to the decorative top layer of ink or dye.

5. The method of claim 4 in which step (b) comprises applying a bottom layer of ink or dye onto the first area on the first surface of the substrate that blocks the passage of light.

6. The method of claim 4 in which step (c) comprises applying light-blocking ink or dye onto the second area of the first surface of the substrate to form the security design.

7. The method of claim 4 in which step (d) comprises applying a first intermediate layer of ink or dye over the bottom layer, said first intermediate layer being effective to reflect light.

8. The method of claim 7 in which step (d) further includes applying a second intermediate layer over the first intermediate layer, the second intermediate layer forming a play surface.

9. The method of claim 8 in which step (d) further includes applying a third intermediate layer over the second intermediate layer, the third intermediate layer including play data.

10. The method of claim 9 in which step (d) further includes applying a fourth intermediate layer over the third intermediate layer, the fourth intermediate layer including a scratch release material, which, when removed, exposes the play data on the third intermediate layer for viewing.

11. A method of enhancing the security of a scratch-off lottery ticket, comprising:
(a) providing a rotating cylinder having a surface including a first engraved portion and a second engraved portion which are spaced from one another along the longitudinal axis of the rotating cylinder, the second engraved portion forming a security design;
(b) applying a first ink or dye to the surface of the rotating cylinder;
(c) transferring the first ink or dye from the first engraved portion of the surface of the rotating cylinder onto a first surface of a substrate to form a bottom layer of the first ink or dye in a first area of the substrate, and transferring the first ink or dye from the second engraved portion of the surface of the rotating cylinder onto the first surface of a substrate so that the security design is applied to a second area of the substrate, the first and second areas of the substrate being spaced from one another;
(d) applying at least one intermediate layer of ink or dye that overlaps the first layer and is located within the first area, the at least one intermediate layer including play data;
(e) applying a decorative top layer of ink or dye that overlaps the at least one intermediate layer and covers the security design so that the security design is not visible to the human eye except upon the application of a source of radiant energy to a second surface of the substrate opposite the first surface or to the decorative top layer of ink or dye.

12. The method of claim 11 in which step (b) comprises applying ink or dye to the surface of the rotating cylinder that blocks the passage of light.

13. The method of claim 11 in which step (d) comprises applying a first intermediate layer of ink or dye over the bottom layer, the first intermediate layer being effective to reflect light.

14. The method of claim 13 in which step (d) further includes applying a second intermediate layer over the first intermediate layer, the second intermediate layer forming a play surface.

15. The method of claim 14 in which step (d) further includes applying a third intermediate layer over the second intermediate layer, the third intermediate layer including the play data.

16. The method of claim 15 in which step (d) further includes applying a fourth intermediate layer over the third intermediate layer, the fourth intermediate layer including a scratch release material, which, when removed, exposes the play data on the third intermediate layer for viewing.

17. A scratch-off lottery ticket, comprising:
a substrate having a first surface and an opposed second surface;
a bottom layer of ink or dye applied to a first area on said first surface of said substrate;
a security design of ink or dye applied to a second area on said first surface of said substrate, said second area being spaced from said first area;
a number of intermediate layers of ink or dye applied one on top of the other and overlapping said bottom layer, at least a first one of said intermediate layers including play data and at least a second one of said intermediate layers including a scratch release material, which, when removed, exposes said play data for viewing;
a decorative top layer of ink or dye applied over the uppermost one of said intermediate layers and applied over said security design so that the security design is not visible to the human eye except upon the application of a source of radiant energy to said second surface of said substrate or to said decorative top layer of ink or dye.

18. The ticket of claim 17 further including a third intermediate layer located between said bottom layer and said first one of said intermediate layers including play data, said third intermediate layer being formed of ink or dye that reflects light.

19. The ticket of claim 18 further including a fourth intermediate layer located between said third intermediate layer and said first one of said intermediate layer including play data, said third intermediate layer being forming a play plate area.
